(19) United States
(12) Patent Application Publication
(10) Pub. No.: US 2006/0186216 A1
(43) Pub. Date: Aug. 24, 2006

(54) Hot water alert integrated within posable toy

(76) Inventors: Taiming Chen, Los Gatos, CA (US); Tzu-Hsin Yang, Los Gatos, CA (US)

Correspondence Address: Taiming Chen, 150 Forest Hill Dr, Los Gatos, CA, 95032, US

(21) Appl. No.: 11/258,818

(22) Filed: Oct. 26, 2005

Related U.S. Application Data
(60) Provisional application No. 60/655,023, filed on Feb. 22, 2005.

(51) Int. Cl. B60H 1/00; G05D 23/00; G01K 13/00

(52) U.S. Cl. 236/94; 165/11.1; 62/129

(57) ABSTRACT

A hot water temperature alert device in shape of toy animal or cartoon figure includes a plurality of posable limbs for securing device on shower head or water faucet, a posable tail for delivering water temperature sensing thermostat switch to a desired position that is under water flow. Device offers visual and/or audible alert when preset water temperature has been met for reminding user that water is already warm enough.

### CROSS-REFERENCE TO RELATED APPLICATIONS

This application is related to and claims priority from U.S. Provisional Patent Application Ser. No. 60/655,023 filed on Feb. 22, 2005

### FIELD OF THE INVENTION

The present invention relates, in general, to a water temperature sensing device in shape of toy animal or figure that can be attached to shower head or positioned on the side of water faucet and offers visual and/or audible indication of proper water temperature has been reached.

### BACKGROUND OF THE INVENTION

Cold weather can affect water pipes and water in them. When water stalled in cold weather after a period of time, the initial water come out of those pipes can be frigid and it may take several minutes for hot water from water heater to go through faucet to reach at user's end.

This invention, while looks entertaining and interesting, may be positioned next to a water faucet or grip on a shower head. Its thermostat can be positioned to under running water via a posable extension for monitoring water temperature. Freeing user up from repeated manual testing of water temperatures. Once water temperature has risen over a preset threshold, this device offers a visual and/or audible alert to remind user that water is warm enough already.

U.S. Pat. No. 5,482,078 to Thomas Yeh discloses a water faucet fitting that is able to produce music. U.S. Pat. No. 4,964,836 to Kamei Masato discloses a posable toy animal that may be bent into different poses.

### BRIEF SUMMARY OF THE INVENTION

The purpose of the invention is to offer an attach-on device to water faucet or shower head, which not only monitors water temperature but also process entertaining and interesting look.

The main feature of the present invention is a device with thermostat switch that turns on once preset temperature threshold has been reached, and then it offers visual and/or audible alarm for reminding user that water temperature is already warm enough.

Further, a plurality of posable limbs comes out from the device's body may be bent to grip over water pipe or to form a stand for positioning the device.

Further, a lengthy posable extension, with electrical wires concealed inside and thermostat on its tip, may be bent to a pose so the thermostat switch can be delivered to a position where is under water flow while the device's body is away at a dry position.

Further, the device with limbs and extension may form a shape that mimics animal with tail or cartoon character for decorative or entertaining purpose.

### BRIEF DESCRIPTION OF THE DRAWINGS

FIG. 1 is a perspective view of this invention is in shape of toy monkey and attaching to a shower head.

FIG. 2 is a perspective view of this invention is in shape of toy monkey and placed on the side of water faucet.

FIG. 3 is an elevation view showing the toy monkey of FIG. 2 in phantom outline and the bendable framework of the present invention;

FIG. 4 is a perspective view of this invention is in shape of toy lizard and attaching to a shower head.

FIG. 5 is a perspective view of this invention is in shape of toy lizard and placed on the side of water faucet.

### DETAILED DESCRIPTION OF THE PREFERED EMBODIMENT

Prior to proceeding to the more detailed description of the present invention, it should be noted that, for the sake of clarity and understanding, identical components which have identical functions have been identified with identical reference numerals throughout the several views illustrated in the drawing figures.

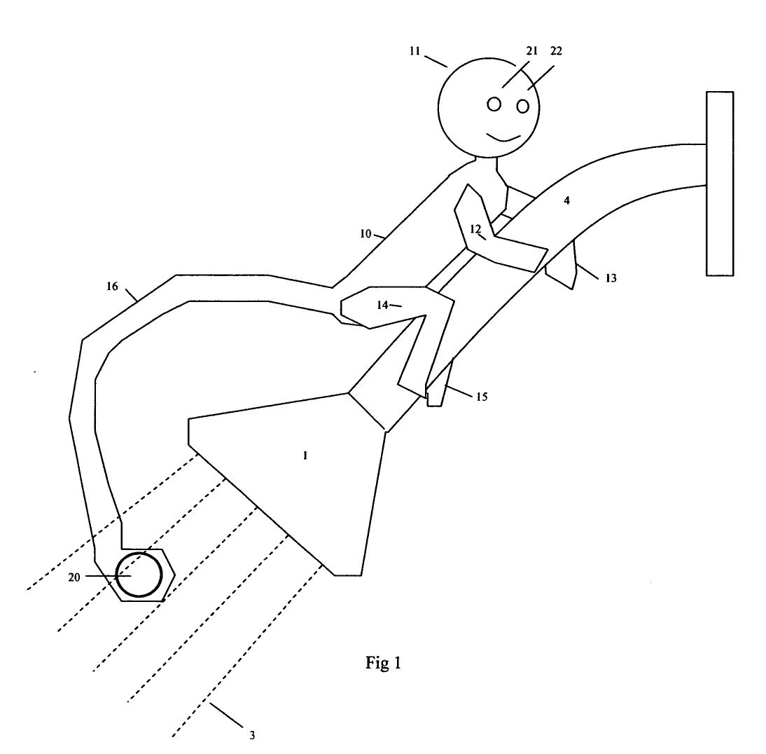

FIG. 1 shows a toy monkey 10 gripping on water pipe of a shower head 1. Two posable arms 12 and 13, along with two posable legs 14 and 15 enable monkey 10 to hold around the water pipe 4 of shower head 1 for getting a fix position. A posable tail 16 places thermostat switch 20 to a position where is under water flow 3 when shower head is turned on.

Thermostat switch 20 can be a simple bimetal thermostat with preset temperature threshold which is higher than lower end of comfortable shower water temperature and is higher than normal room temperature. When water temperature is below this threshold, the switch is off therefore there is no sound or light alert from this device. When water temperature raises above this preset temperature, thermostat switch 20 turns on and this device offers a beeping or musical sound from a speaker on the circuit box 23, and blinking lights from two LED eyes 21 and 22.

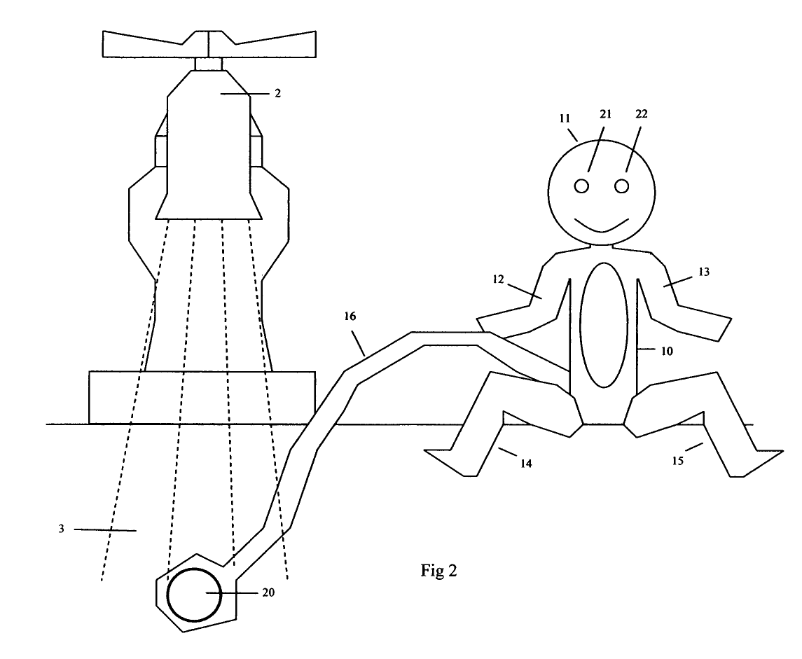

FIG. 2 shows the same toy monkey 10 sits along with its two posable legs 14 and 15 at a position near to a water faucet 2. Its posable tail 16 delivers thermostat switch 20 to a position where is under water flow 3 when the faucet is turned on

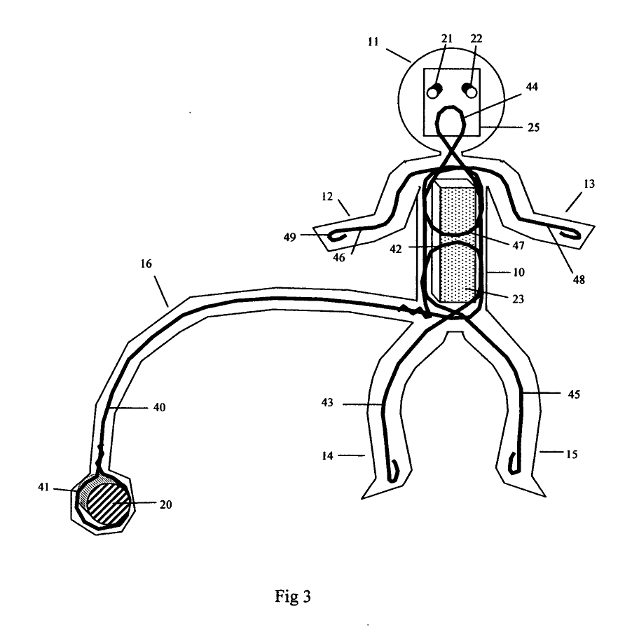

FIG. 3 shows the construction of the toy monkey 10 as a commercial article of manufacture being completed by an external covering and internal bendable wire framework beneath the covering. External covering can be made of one-piece molded skin, preferably formed of a plastic or rubber material for waterproofing. The posable limbs and tail are supported by bendable internal framework, which basically consists in this case of three linear framework members made of bendable metal wires. There are some overlapped areas among these members, and these members are held together by welded bounds. A first member has a first loop portion 41 which surrounds thermostat switch 20 and, a second portion 40 goes through tail 16, and a third portion 42 which forms a loop within torso 10. A second member has a first portion 43 extending through right leg 14 and torso 11, a second portion 44 which forms a loop within head 11, and a third portion 45 which extends through torso and left leg 15. Third member has a first portion 46 extending through right arm 12, a second portion 47 which forms a loop within torso 11, a third portion 48 which extends through left arm 13. The portions 40, 43, 45, 46, and 48 are linear framework members having a central core consisting of flexible metal wire, so that each of these portions, which extend substantially centrally and longitudinally through their respective limb or tail of the toy, is bendable. However, there is a rigid box 23 which contains battery and circuit for the visual and audible alarm hides within torso 11, and multiple members of framework also go through torso 11, therefore torso of this toy isn't bendable.

In this preferred embodiment of the invention, the terminal end of each linear framework member at the outer terminus of a limb is retroflexed, e.g., terminal end 49 of member 46 is retroflexed within arm 12. Thus the terminal end of the wire portion of the member portion 46 is bent away from direct contact with the outer terminus arm 12, and therefore the wire end cannot tend to work or tear through the arm 12. As shown in FIG. 3, the terminal ends of member portions 43, 45, 46 and 48 within their respective terminal limb members 14, 15, 12 and 13 are also retroflexed.

FIG. 3 also shows thermostat switch 20 is bonded to frame member 41, circuit box 23 hides within torso 11, and head circuit board 25 hides within toy's head 11 and is bounded with frame member 44, with two LED lights 21 and 22 on it to pose as toy's eyes.

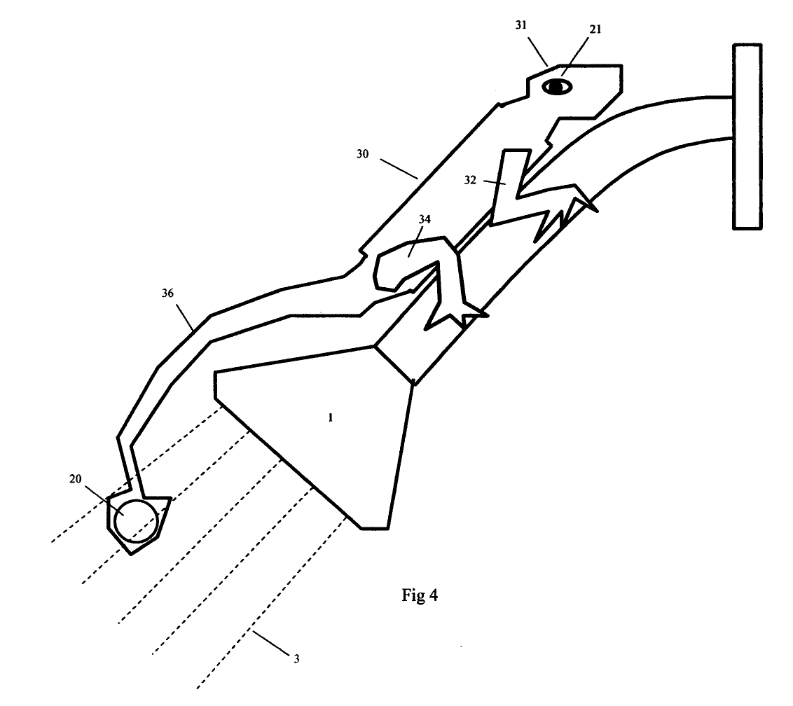

FIG. 4 is similar to FIG. 1, except the monkey is replaced by a toy lizard 30.

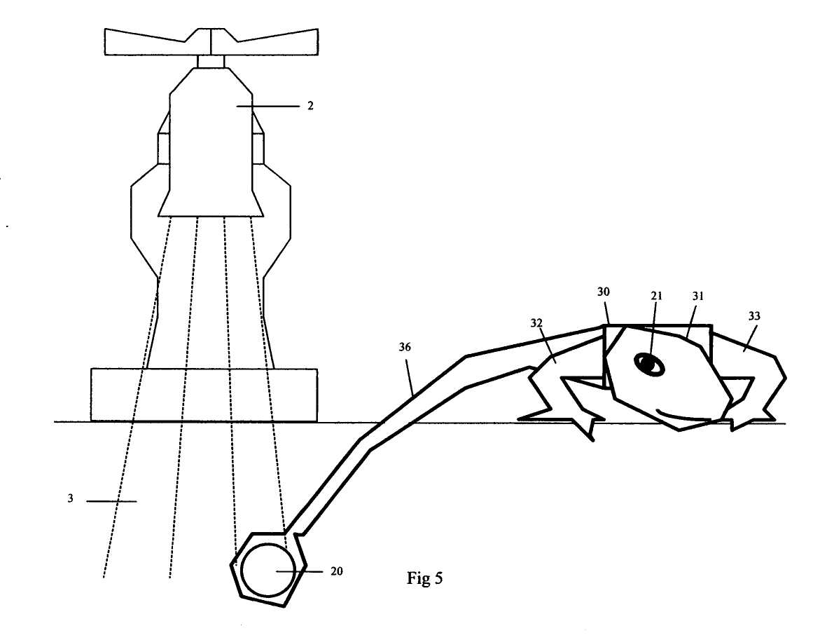

FIG. 5 is similar to FIG. 2, except the monkey is replaced by a toy lizard 30.

I claim:

1. A device for alerting hot water has reached to users end, said device comprising:
(a) a temperature sensing thermostat switch that turns on when it senses water temperature is above a preset threshold;
(b) a circuit, powered by battery, that is able to produce light or sound as visual or audible alarm when thermostat switch has been turned on;
(c) a predetermined plurality of posable limbs comes out from the device for gripping over water pipe, or for forming a stand to support the device to a fixed first position;
(d) a lengthy posable extension carries the thermostat switch which is connected to circuit and places the switch to a desired second position where is under running water for sensing water temperature.

2. The device as recited in claim 1, wherein the device is made into the shape of toy animal or cartoon character for entertaining and interesting look.

3. The device as recited in claim 1, wherein the device use sucking cup(s) to get a fixed first position on a flat surface.

4. The device as recited in claim 1, wherein the device can be fastened to water pipe to get a fixed first position.

5. The device as recited in claim 1, wherein the circuit offers visual or audible alert only for a predetermined period of time before it automatically cut off to conserve battery energy.

6. The device as recited in claim 1, wherein the circuit offers programmed speech phrases instead of simple audible sound to remind user.

7. The device as recited in claim 1, wherein the device has an adjustable thermostat switch that allows user to adjust alarm triggering water temperature.

8. The device as recited in claim 1, wherein the circuit offers radio signal to a wireless computer network.
